(19) United States
(12) Patent Application Publication
(10) Pub. No.: US 2013/0260350 A1
(43) Pub. Date: Oct. 3, 2013

(54) ELECTRONIC READER FOR ENHANCING INTERACTIVE ONLINE LEARNING EXPERIENCE

(71) Applicant: LOUDCLOUD SYSTEMS INC., Dallas, TX (US)

(72) Inventors: Manoj Kutty, Dallas, TX (US); Anil Vishwanath Sonkar, Andheri (IN); Dinesh Warrier, Mumbai (IN)

(73) Assignee: LoudCloud Systems Inc., Dallas, TX (US)

(21) Appl. No.: 13/853,302

(22) Filed: Mar. 29, 2013

Related U.S. Application Data
(60) Provisional application No. 61/618,500, filed on Mar. 30, 2012.

(51) Int. Cl. G09B 19/00

(52) U.S. Cl. CPC G09B 19/00
USPC 434/308

(57) ABSTRACT

Disclosed is a method and system for enabling an electronic reader embedded on e-learning system. In one implementation, the system comprises a Graphical User Interface (GUI) module, a receiving module, a capturing module, a generating module, a database and a communication module. The GUI module is configured to display a first content object to one or more users connected on the online e-learning platform. The receiving module is configured to receive an electronic input signal from a user to highlight a first sub-content object in the first content object. The capturing module is configured to capture first metadata associated with the first sub-content object. The generating module is configured to generate a second content object comprising the first sub-content highlighted based on the first metadata. The database is configured for storing the second content object. The communication module is configured to share the second content object in real-time.

### PRIORITY CLAIM

This disclosure claims priority under 35 U.S.C. §119 to U.S. Provisional Application No. 61/618,500, filed Mar. 30, 2012, and entitled “AN ELECTRONIC READER FOR ENHANCING INTERACTIVE ONLINE LEARNING TECHNOLOGY.” The aforementioned application is incorporated herein by reference in its entirety.

### TECHNICAL FIELD

The present subject matter described herein, in general relates to online e-learning systems, and more particularly to electronic content readers embedded on the online e-learning systems.

### BACKGROUND

Web-based learning techniques have evolved and gained immense popularity in the last few years. The web-based learning techniques have facilitated online education for students, instructors and course-seekers using internet as a medium. With the widespread availability of the Internet, many “distance learning” systems have been made available across the globe, and in fact, use of such systems is one of the fastest growing applications of information and communication technology. Many institutions, including but not limited to colleges, universities and even corporate establishments, are instituting e-learning systems as an effective means to dissipate knowledge.

The e-learning systems are usually provided with an embedded electronic content reader. The electronic content reader is an interface embedded to the e-learning system that allows students to read course material, textbooks and other learning materials on their electronic devices such as mobile phones, tablets, laptops and computers etc. Such textbooks, learning materials and other course contents may comprise numerous pages and therefore the user engagement and participation levels has to be promoted by means of various features in such electronic content readers.

Electronic content readers enhance the user experience by enabling the users to access, review, modify and share the contents on the e-learning systems with their peers. However, the need in the art is to explore the possibilities, as how these electronic content readers can be upgraded further.

One such technical problem is explained by way of the following example: A lot of content placed on different pages of a textbook may require instructor's guidance for a student who is reading a textbook using a conventional electronic content reader. The student may be required to share such contents with the instructor to understand the contents in more detail. Since the contents are located on different pages, it is difficult for the student to memorize the content, the page where the content is located in the textbook and the specific location of the content in that particular page. The student would generally use a highlight feature available in the conventional electronic content reader that enables him to highlight the particular content followed by an optional step of adding annotations thereto. However, this approach has certain limitations, since the student has to scroll the entire textbook manually to recap the highlights and annotations. Similarly, the instructor will have to scroll through the entire textbook to locate the content that has been highlighted by the student and then analyze the annotations associated therewith and accordingly provide his guidance to the student. Thus, the process is inefficient and onerous. Also, there is no provision in the conventional electronic content readers that enables a student to instantaneously locate the other users such as students, instructors in the e-learning system who are reading the same textbook so that real time communication can be established and discussion on the highlighted/annotated portion be facilitated with such users.

### SUMMARY

This summary is provided to introduce concepts related to systems and methods for providing an electronic content reader embedded on e-learning systems and the concepts are further elaborated below in the detailed description. This summary is not intended to identify all essential features of the claimed subject matter nor is it intended for use in determining or limiting the scope of the claimed subject matter.

In one implementation, an e-learning system for enabling an electronic content reader application is disclosed. The e-learning system comprises a processor and a memory coupled to the processor for executing a plurality of modules present in the memory. The plurality of modules comprises a Graphical User Interface (GUI) module, a receiving module, a capturing module, a generating module, and a communication module. The GUI module is configured to display a first content object on the electronic content reader to one or more users connected on the e-learning system. The receiving module is configured to receive an electronic input signal from at least one user from the one or more users to highlight at least one first sub-content object in the first content object. The capturing module is configured to capture first metadata associated with the at least one first sub-content object in response to the electronic input signal received. The generating module is configured to generate a second content object comprising the at least one first sub-content highlighted based on the first metadata. A database is configured for storing the second content object. The communication module is configured to share the second content object to at least one other user from the one or more users in real time.

In another implementation, a method for enabling an electronic content reader embedded on an e-learning system is disclosed. A first content object on the electronic content reader is displayed to one or more users connected on the e-learning system. An electronic input signal is received from at least one user from the one or more users to highlight at least one first sub-content object in the first content object. First metadata associated with the at least one first sub-content object is captured in response to the electronic input signal received. A second content object comprising the at least one first sub-content highlighted is generated based on the first metadata. Further, the second content object is shared to at least one other user from the one or more users in real time.

In another implementation, a computer program product having embodied thereon a computer program for enabling an electronic content reader embedded on an e-learning system is disclosed. The computer program product comprises a program code for displaying a first content object on the electronic content reader to one or more users connected on the e-learning system. A program code is configured for receiving an electronic input signal from at least one user from the one or more users to highlight at least one first sub-content object in the first content object. A program code is configured for capturing first metadata associated with the at least one first sub-content object in response to the electronic input signal received. A program code is configured for generating a second content object comprising the at least one first sub-content highlighted based on the first metadata. A program code is then configured to share the second content object to at least one other user from the one or more users in real time.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of an e-learning system enabling an electronic content reader, in accordance with an embodiment of the present subject matter.

FIG. 2 illustrates the e-learning system, in accordance with an embodiment of the present subject matter.

FIG. 3 illustrates a method for enabling an electronic content reader on the e-learning system, in accordance with an embodiment of the present subject matter.

FIG. 4 illustrates an electronic content reader, in accordance with an embodiment of the present subject matter.

### DETAILED DESCRIPTION

Systems and methods for enabling an electronic reader embedded on e-learning systems are now described in detail. The present disclosure discloses an effective and efficient mechanism for enabling a user to highlight and annotate first sub-content objects in first content objects. In an embodiment, the first content objects may comprise files, documents, libraries and/or textbooks associated with course material displayed on the electronic reader. The first sub-content objects may comprise texts, comments, hyperlinks, and multimedia such as audio and video. The electronic reader may be enabled to generate a second content object depicting a composite summary of highlighted first sub-contents along with annotations (if any) in the course material on the electronic reader. The second content object can further be saved as a separate document depicting only the first sub-contents highlighted by the user with or without annotations. The separate document can then be shared over the e-learning system for annotation by other users.

In order to generate such a second content object as highlight summary, the at least one first sub-content object from at least one first content object in the electronic reader to be highlighted may be selected in response to an input received from a user. In one example, the first sub-content object to be selected for highlighting may include, without limitation, a text, a comment, a note, a hyperlink, an audio, and a video. The at least one first content object may be related to the course material in the electronic content reader, wherein such course material may be in the form of word processing files, multimedia files, audio files, video files, publications and textbooks being displayed on the electronic content reader.

Subsequent to the selection of the first sub-content object for highlighting, first metadata associated with the first sub-content object may be generated. The first metadata captured may include the first sub-content selected for highlighting, location of the first sub-content, starting position of first sub-content, length of the first sub-content, and the identifier of the user selecting the first sub-content for highlighting. The user can select number of first sub-content from the first content object for highlighting. For each of the first sub-content selected, the first metadata may be captured. The first metadata captured may be then stored in a database for later use and retrieval.

After the selection of the first sub-content for highlighting, the user may optionally want to add annotation to the first sub-content selected for highlighting. In one example, the user can annotate the first sub-content by adding a comment, a text, an image, a hyperlink, an audio, and a video to the first sub-content selected for highlighting. Subsequent to the annotation of the first sub-content, a second metadata associated with the annotated first sub-content may be captured and stored in the database. The second metadata stored may include, without limitation, text, multimedia (image, audio, and video), code, and Web link.

Subsequent to generation of the first metadata and the second metadata, the second content object in the form of highlight summary may be generated. In order to enable generation of the highlight summary, the first metadata may be used for identifying the first sub-content highlighted in the first content object. The first metadata may be referred from the database and the second content object comprising all the highlighted first sub-contents may be generated.

The first metadata captured may track the location, the starting position and the length of the first sub-content to generate the second content object. The first sub-content(s) highlighted in the second content object may also optionally be accompanied with the annotations made by the user. The second content object may be stored in the database for later use and retrieval.

The second content object can then be shared over the e-learning system. The users connected with the e-learning system over the network can collaborate over a discussion forum, a blog or a chat session in order to view and discuss the second content object and associated annotations. The users can also contribute to the first sub-content(s) by annotating their comments, notes, images and multimedia in the first sub-content(s). These annotations from the users can further be stored in the database for later user and retrieval.

While aspects of described system and method for enabling an electronic reader on e-learning systems may be implemented in any number of different computing systems, environments, and/or configurations, the embodiments herein are described in the context of the following exemplary system.

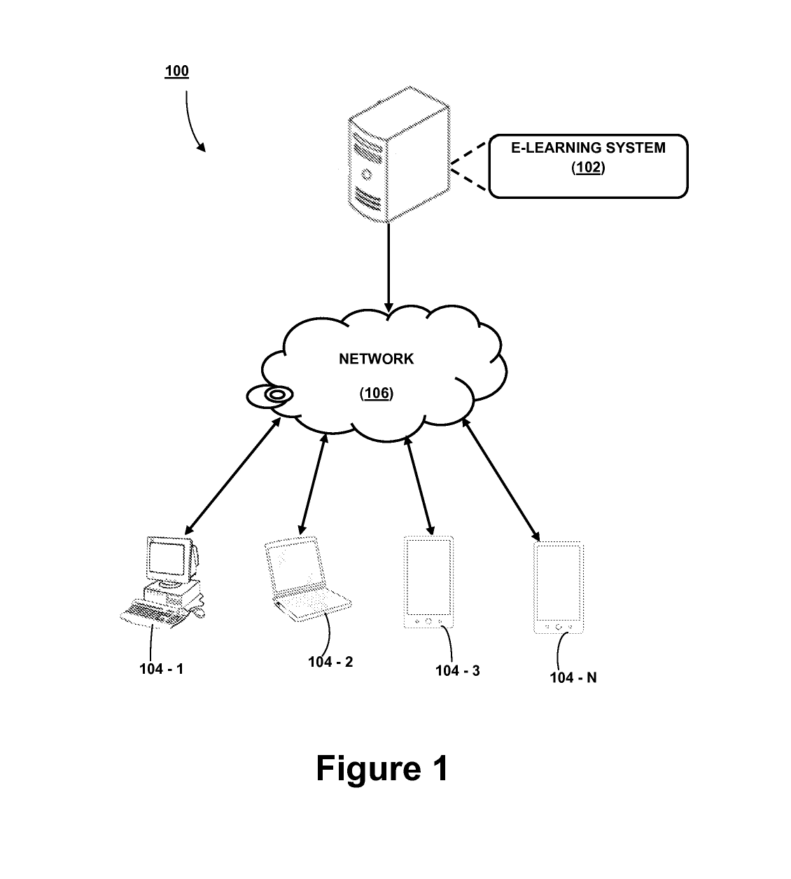

Referring now to FIG. 1, a network implementation 100 of an e-learning system 102 for enabling an electronic reader is illustrated, in accordance with an embodiment of the present subject matter. In one embodiment, the e-learning system 102 provides for real time, i.e. on the run creation and modification of first sub-content objects in the electronic reader based on the user's interest. In one embodiment, the e-learning system 102 may enable the user to select one or more first sub-contents to be highlighted from a first content object displayed on the e-learning system 102. After selection of the one or more first sub-contents by the user, the e-learning system 102 may capture first metadata associated with the first sub-contents being highlighted. Based upon the captured first metadata, the e-learning system 102 may generate a second content object comprising the highlighted first sub-contents. The second content object may depict summary of all the highlights in the first content object displayed on the e-learning system 102, wherein the second content object may be further shared to other users connected on the e-learning system 102.

Although the present subject matter is explained considering that the e-learning system 102 is implemented as an electronic content reader on a server, it may be understood that the e-learning system 102 may also be implemented in a variety of computing systems, such as a laptop computer, a desktop computer, a notebook, a workstation, a mainframe computer, a server, a network server, and the like. It will be understood that the e-learning system 102 may be accessed by multiple users through one or more user devices 104-1, 104-2 . . . 104-N, collectively referred to as user 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106. Further, the user 104 can be at least one of a student, an instructor, and an administrator etc collaborating over the network 106 for facilitating online education.

In one embodiment, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

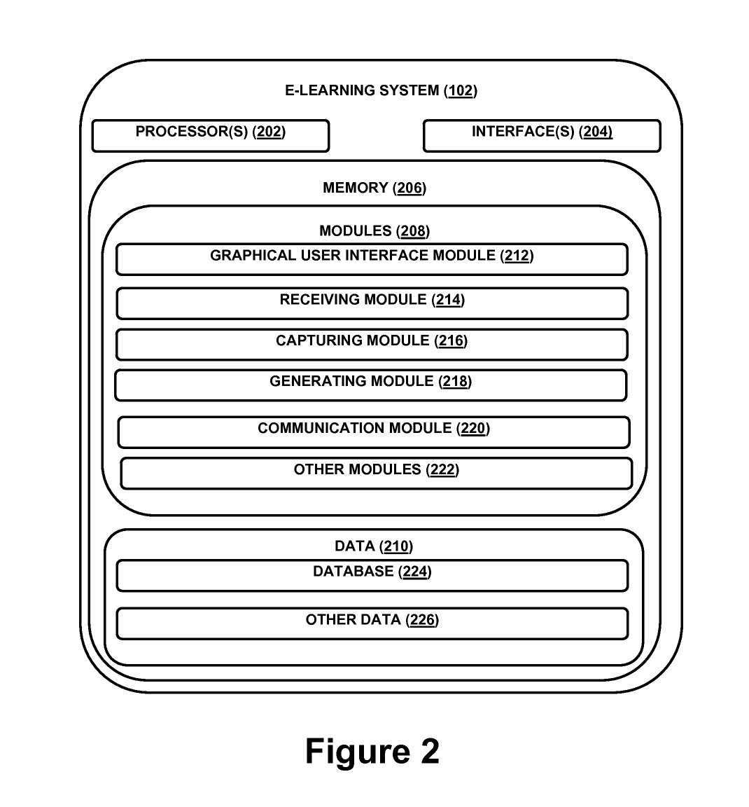

Referring now to FIG. 2, the e-learning system 102 is illustrated in accordance with an embodiment of the present subject matter. In one embodiment, the e-learning system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the e-learning system 102 to interact with a user directly or through the client devices 104. Further, the I/O interface 204 may enable the e-learning system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a graphical user interface module 212, a receiving module 214, a capturing module 216, a generating module 218, a communication module 220 and other modules 222. The other modules 222 may include programs or coded instructions that supplement applications and functions of the system 102.

The data 210, amongst other things, serves as a repository for storing data processed, received, and generated by one or more of the modules 208. The data 210 may also include a database 224 and other data 130. The other data 130 may include data generated as a result of the execution of one or more modules in the other module 222.

In one embodiment, at first, a user may use the client device 104 to access the e-learning system 102 via the I/O interface 204. The user may register using the I/O interface 204 in order to use the e-learning system 102. The e-learning system 102 may enable the modules to configure an electronic content reader (not shown in figure) that can be accessible by the user devices 104 through the I/O interface 204. The electronic content reader may be a web browser enabled application, allowing the distribution of first content objects across the network 106 and on the user devices 104. The e-learning system 102 may be used for generating a summary of highlighted first sub-contents in the first content objects. The modules 208 are executed to enable the electronic content reader for generating the summary of the highlighted first sub-contents.

In order to generate the summary of highlighted first sub-contents, the e-learning system 102, at first, may display at least one first content object to the user. Specifically, in the present implementation, the first content object may be displayed to the user by the Graphical User Interface (GUI) module 212. In one implementation, the first content object that is displayed to the user comprises electronic documents such as spreadsheets, word processing files, HTML files, or multimedia files including audio or video files etc. Further, the first content object may comprise at least one first sub-content object. In one implementation, the first sub-content object may comprise texts, comments, notes, hyperlinks, audios, and videos. The user can create, view, edit and share the first sub-content objects displayed on the electronic reader through the Graphical User Interface (GUI) module 212.

In one embodiment, the receiving module 214 may receive at least one electronic input signal from the user in order to create, view, modify and share the first sub-content object. The user may be provided with an option to either highlight or annotate the first sub-content object. When the input signal is received from the user for highlighting the first sub-content object, the e-learning system 102 may automatically trigger the capturing module 216 to perform one or more designated tasks. The capturing module 216 may enable capturing of first metadata associated with the first sub-content object being selected for highlighting, in response to the input signal received from the user. In one embodiment, the first metadata captured by the capturing module 216 may comprise location of the first sub-content object, the starting position of the first sub-content object, the identifier of the user highlighting the first sub-content object, and the date and time of highlighting the first sub-content object. The first metadata captured may be then stored in the database 224. Thus, the database 224 may contain lists of one or more first sub-content objects from the first content object being highlighted by the user and the corresponding first metadata captured for each of the first sub-content objects.

In one embodiment the user 104 may be also enabled to annotate the first sub-content object being highlighted. When the input signal is received from the user for annotating the first sub-content object being highlighted, the e-learning system 102 may prompt the user to annotate the first sub-content for annotation. The user may be then enabled to perform annotation on the first sub-content being highlighted by adding text, comment, note, web enabled link and multimedia etc. In response to such annotation, the e-learning system 102 may automatically trigger the capturing module 216 to perform one or more designated tasks. The capturing module 216 may enable capturing of second metadata associated with the first sub-content object being highlighted, in response to the input signal received from the user for annotating the first sub-content object. In one embodiment, the second metadata captured by the capturing module 216 may comprise location of the first sub-content object, the starting position of the first sub-content object, the identifier of the user annotating the first sub-content object, and the date and time of annotating the first sub-content object. Further, the second metadata may include title of the annotation, description of the annotation, text, comment, note, web enabled link and multimedia etc. The second metadata captured may be then further stored in the database 224. Thus, the database 224 may also contain lists of one or more highlighted first sub-content objects being annotated by the user and the corresponding second metadata captured for each of the highlighted first sub-content objects.

In one embodiment, the first metadata stored in the database 224 may be utilized for generating at least one second content object in the form of highlights summary. The first metadata associated with the at least one first sub-content object in the first content object may be utilized by the generating module 218 for generating the second content object depicting the highlights summary. Specifically, the first metadata may enable retrieval of the at least one first sub-content object highlighted by the user and append only the at least one first sub-content object highlighted in the second content object. Thus, the second content object may be generated comprising the one or more first sub-content objects being highlighted by the user 104. In one embodiment, each of the first sub-content objects in the second content object may be accompanied with the annotations made by the user using the second metadata stored in the database 224. Thus, the second content object may contain the at least one first sub-content object being highlighted along with the annotations of the user associated therewith.

In one embodiment, the first metadata can optionally be used for highlighting the other sub-content objects matching with the first sub-content objects in the first content object. Specifically, the first metadata may enable identification of at least one second sub-content object located at a location other than the location of the first sub-content object in the first content object matching with the first sub-content object. The at least one second sub-content object identified may be automatically highlighted and stored in the database 224 for later use. The second sub-content object may also be included in the second content object generated by the generating module 218.

In one embodiment, the second content object generated can be stored in the database 224 for later use and retrieval. The second content object can be shared on the e-learning system to other user devices 104-1, 104-2 . . . 104-N collaborated over the network with the user device 104. The user devices 104-1, 104-2 . . . 104-N can collaborate using the communication module 220 to initiate communication such as a chat session, a discussion forum and a networking blog etc. The users of the user devices 104-1, 104-2 . . . 104-N can ‘like’ or ‘dislike’ the second content object being shared. The e-learning system 102 can maintain a counter of likes and dislikes of the users connected over the network 106. Further, at least one user on the network 106 can monitor the at least one other user reading the first content object and accordingly initiate a chat communication with the other user. The second content object being shared over the network can be reviewed by the at least one other user. The at least one other user can also add annotation in the at least one first sub-content object in the second content object and share the annotations in the second content object to the user 104. This sharing of the second content object along with annotation may enable the users to keep themselves engaged with the e-learning system 102.

In one embodiment, at least one user 104, preferably, a student can select at least one first sub-content, for example a text, to be highlighted in at least one first content object, for example a textbook displayed on the electronic content reader. Metadata associated with the text such as location in the textbook, the starting position of the text, the length of the text and the user-id of the student may be captured and stored in the database 224. Further, the student may add annotation in form of comment to understand the details of the text, wherein the metadata associated with the comment may be also captured. Using the metadata, at least one second content object, for example a highlight summary document comprising texts highlighted by the student in the textbook may be generated. The student can share the highlight summary document along with annotated comments to the at least one other user, preferably, an instructor. The instructor can review the text highlighted along with the comment from the student and further annotate the text highlighted by adding his/her response in form of text, audio, and video etc. Further, the instructor may also provide a link to an online resource from where the additional details of the text highlighted may be extracted. The student can monitor the list of other users on the electronic reader reading the same textbook and can initiate the chat session or discussion forum with the other users for discussing the first sub-contents of the textbook. Specifically, each first sub-content highlighted by the student may be identified and metadata associated with each first sub-content highlighted may be then stored in the database 224. Further, instead of reviewing the entire textbook, the student can generate the second content object in the form of the highlight summary displaying only the first sub-content(s) highlighted by him/her while reading the entire textbook. This may enable the student to selectively filter the first sub-contents from the textbook that needs to be shared with the instructor for resolving any query the student had with respect to the first sub-content(s) highlighted. Similarly, the instructor can selectively filter the queries received from the student and accordingly address them.

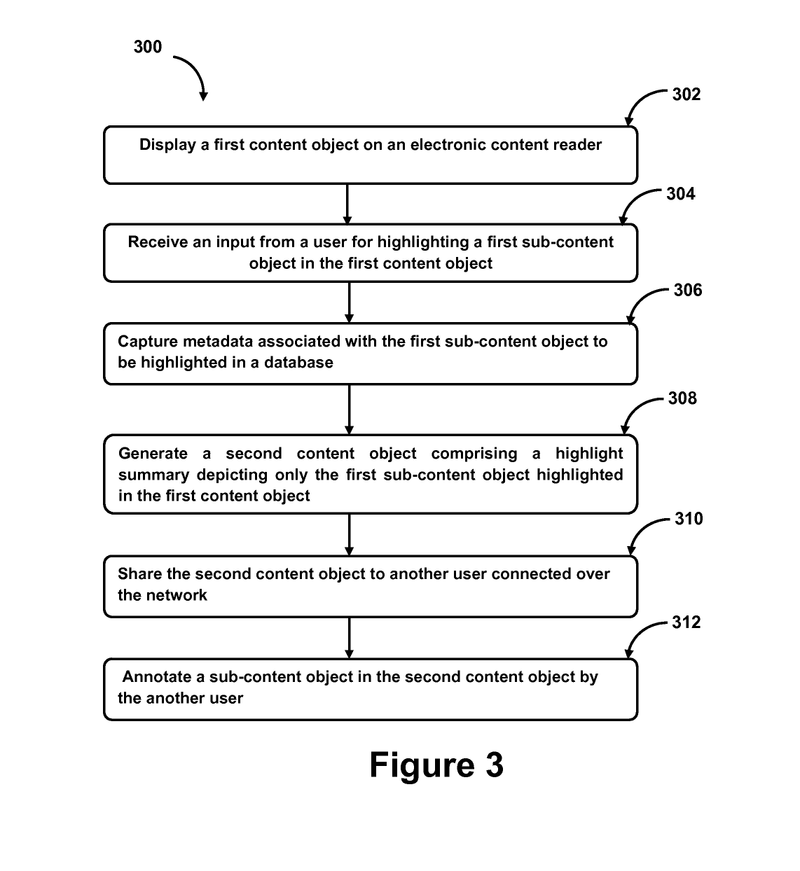

Referring now to FIG. 3, a method 300 for enabling an electronic content reader on an e-learning system is illustrated in accordance with an embodiment of the present subject matter. The method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 300 may be considered to be implemented in the above described e-learning system 102.

At block 302, a first content object may be displayed on an electronic content reader to one or more user connected on the e-learning system.

At block 304, an input for highlighting a first sub-content object in the first content object by a user may be received by the receiving module 214. The user can also annotate the first sub-content object selected for highlight.

At block 306, first metadata associated with highlighting the first sub-content object may be captured by the capturing module 216. Further, second metadata associated with annotating the first sub-content object may be also captured.

At block 308, using the first and the second metadata, a second content object comprising the first sub-content object being highlighted with associated annotations may be generated using the generating module 218.

At block 310, the second content object may be shared to at least one other user connected over the network 106.

At block 312, the at least one other user can annotate at least one sub-content object in the second content object.

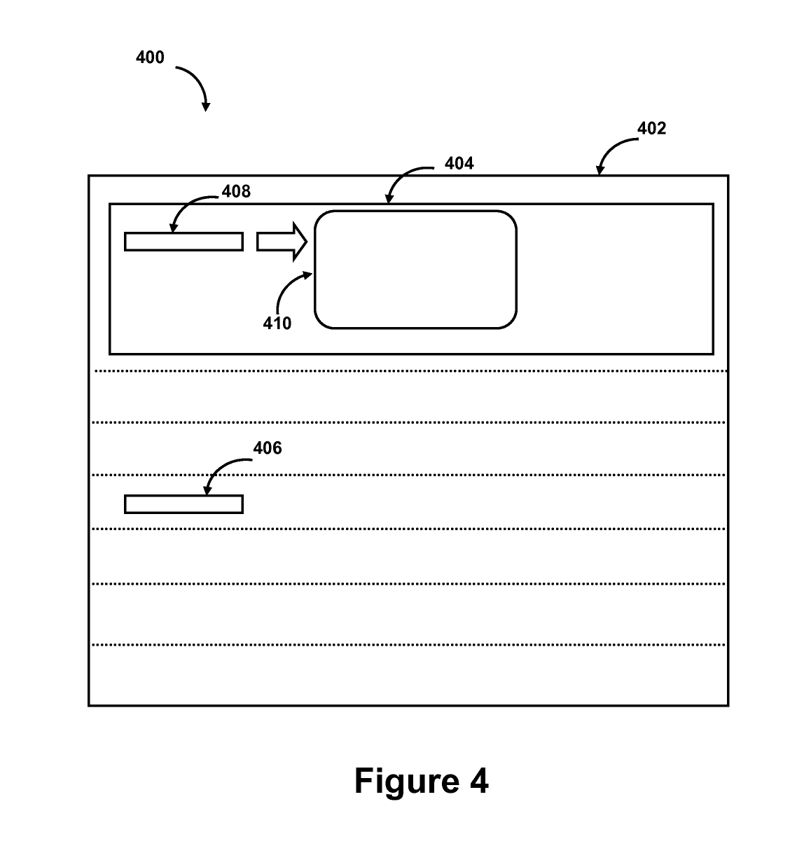

Referring now to FIG. 4, an electronic content reader 400 embedded on an e-learning system is shown in accordance with an embodiment of the present subject matter. As illustrated, the electronic reader 400 may display a first content object 402 to one or more users connected on the e-learning system. At least one user from the one or more users may select a first sub-content 406 in the first content object 402 for highlighting. The at least one user may add annotation in form of an image to the first sub-content 406. As-soon-as the first sub-content 406 may be selected for highlighting and annotation thereof, metadata associated with the highlighted first sub-content 406 and annotated image may be captured. The metadata captured may be then stored in the database 224 for later use and retrieval.

In this embodiment, a second content object 404 in the form of highlight summary may be generated using the metadata stored in the database 224. The second content object 404 may comprise the first sub-contents highlighted in the first content object 402. For example, the first sub-content 408 in the second content object 404 may represent the first sub-content 406 highlighted in the first content object 402. Further, the second content object 404 can be shared over the network by means of a discussion forum or a chat session with other users collaborating over the e-learning system. The other users can view the highlighted first sub-content 408 in the second content object 404 along with the annotations associated therewith, if any. For example, the first sub-content 408 as shown may be accompanied with the annotated image 410, wherein the annotated image 410 may be popped-up on the electronic content reader, when the at least one other user views the first sub-content 408. The at least one other user can further annotate the first sub-content 408 by adding comment, note, or a multimedia to the content 408. The first sub-content 408 being annotated by the at least one other user can then be shared to the at least one user.

Although implementations for methods and systems for providing an electronic content reader embedded on an e-learning system have been described in language specific to structural features and/or methods, it is to be understood that the appended claims are not necessarily limited to the specific features or methods described. Rather, the specific features and methods are disclosed as examples of implementations for providing an electronic content reader embedded on an online e-learning platform.

Exemplary embodiments discussed above may provide certain advantages. Though not required to practice aspects of the disclosure, these advantages may include:

1. Real time generation of a second content object in the form of a highlight summary, wherein the highlight summary comprises of at least one first sub-content highlighted in at least one first content object displayed on an electronic content reader.

2. Real time sharing of the highlight summary to the other users in a discussion forum or a blog or a chat session.

3. Annotation of each highlighted contents in the second content object, wherein the annotations can be contributed by both: the user highlighting the first sub-content, and the other user reviewing it.

4. Real time monitoring of at least one other user connected over the e-learning system reading the first content object to initiate asynchronous communication by means of chat, discussion forum and blog etc.

It is intended that the disclosure and examples above be considered as exemplary only, with a true scope and spirit of disclosed embodiments being indicated by the following claims.

1. A method for enabling an electronic content reader embedded on an e-learning system, the method comprising:
displaying, by a processor, a first content object on the electronic content reader to one or more users connected to the e-learning system;
receiving, by the processor, an electronic input signal from at least one user from the one or more users to highlight at least one first sub-content object in the first content object;
capturing, by the processor, first metadata associated with the at least one first sub-content object in response to the electronic input signal received;
generating, by the processor, a second content object comprising the at least one first sub-content highlighted based on the first metadata; and
sharing, by the processor, the second content object with at least one other user from the one or more users in real time.

2. The method of claim 1, wherein the first content object is selected from a group comprising spread sheets, word processing files, multimedia files including audio or video files, and HTML files.

3. The method of claim 1, wherein the first sub-content object is selected from a group comprising texts, comments, notes, hyperlinks, audios, videos and multimedia.

4. The method of claim 1, wherein the first metadata comprises the first sub-content object, the location of the first sub-content object in the first content object, the starting position of the first sub-content object, the length of the first sub-content object, and the identifier of the at least one user.

5. The method of claim 4, wherein the first metadata is utilized for highlighting at least one second sub-content object in the first content object matching with the first sub-content object located at a location other than the location of the first sub-content object.

6. The method of claim 1, wherein the at least user can annotate the at least one first sub-content object highlighted by adding a comment, a text, an image, a hyperlink, an audio, a video and combinations thereof associated with the at least one sub-content object.

7. The method of claim 6, wherein the annotation of the at least one first sub-content enables capturing second metadata associated with the annotation of the at least one first sub-content comprising title of the annotation, description of the annotation, the identifier of the at least one user, comment, a text, an image, a hyperlink, an audio, and a video.

8. The method of claim 1, wherein the second content object can be stored in a database to be retrieved in future for later use.

9. The method of claim 1, wherein the second content object is shared to at least one other user using a communication module configured for establishing electronic communication such as a chat session, a discussion forum, and a blog.

10. The method of claim 9, wherein the at least one other user is enabled to annotate at least one first sub-content object in the second content object.

11. An e-learning system for enabling an electronic content reader, the e-learning system comprising:
a processor; and
a memory coupled to the processor, wherein the processor is capable of executing a plurality of modules stored in the memory, and wherein the plurality of modules comprising:
a Graphical User Interface (GUI) module configured to display a first content object on the electronic content reader to one or more users connected to the e-learning system;
a receiving module configured to receive an electronic input signal from at least one user from the one or more users to highlight at least one first sub-content object in the first content object;
a capturing module configured to capture first metadata associated with the at least one first sub-content object in response to the electronic input signal received;
a generating module configured to generate a second content object comprising the at least one first sub-content highlighted based on the first metadata;
a communication module configured to share the second content object with at least one other user from the one or more users in real time; and
the memory further comprising a database configured for storing the second content object.

12. The e-learning system of claim 11, wherein the communication module is configured for establishing electronic communication such as a chat session, a discussion forum, and a blog.

13. A computer program product having embodied thereon a computer program for enabling an electronic content reader embedded on an e-learning system, the computer program product comprising:
a program code to display a first content object on the electronic content reader to one or more users connected to the e-learning system;
a program code to receive an electronic input signal from at least one user from the one or more users to highlight at least one first sub-content object in the first content object;
a program code to capture first metadata associated with the at least one first sub-content object in response to the electronic input signal received;
a program code to generate a second content object comprising the at least one first sub-content highlighted based on the first metadata; and
a program code to share the second content object with at least one other user from the one or more users in real-time.
